(19) United States
(12) Patent Application Publication
(10) Pub. No.: US 2026/0071651 A1
(43) Pub. Date: Mar. 12, 2026

(54) LINEAR GUIDE

(71) Applicant: Schneeberger Holding AG, Roggwil (CH)

(72) Inventor: Thomas GROLIMUND, Langenthal (CH)

(73) Assignee: Schneeberger Holding AG, Roggwil (CH)

(21) Appl. No.: 19/308,445

(22) Filed: Aug. 25, 2025

(30) Foreign Application Priority Data
Sep. 10, 2024 (EP) 24199597.6

(51) Int. Cl. F16C 29/00; F16C 29/04; F16C 33/34; F16C 33/46

(52) U.S. Cl. CPC F16C 29/005; F16C 29/045; F16C 33/34; F16C 33/467

(57) ABSTRACT

A linear guide includes a first displacement element; a second displacement element which is linearly moveable along a linear direction relative to the first displacement element; at least one first rolling element set, which is provided between the first and second displacement elements, and which includes at least one rolling element and over which the first and second displacement elements are relatively moveable; and a cage in which at least one rolling element is arranged in a holding section which overlaps with the at least one rolling element in the linear direction. To increase precision and improve the response behavior of the linear guide, the cage includes at least one uneven stiffening structure which is arranged in the holding section and contains at least one recess.

### CROSS REFERENCE TO RELATED APPLICATIONS

Applicant claims priority under 35 U.S.C. § 119 of European Application No. 24199597.6 filed Sep. 10, 2024, the disclosure of which is incorporated by reference.

### BACKGROUND OF THE INVENTION

### 1. Field of the Invention

The present invention relates to a linear guide, in particular, a linear guide, in which two displacement elements are relatively moveable along a linear direction by means of rolling elements arranged between them. The linear guide can be a forced guide.

### 2. Description of the Related Art

For example, a linear guide is known from U.S. Pat. No. 5,553,946 A that comprises two displacement elements that can be moved along a linear direction relative to one another. Between the displacement elements, a plurality of rolling elements are provided along the linear direction. The rolling elements are arranged in a cage. Furthermore, the cage comprises a stiffening structure, which is designed as a thickening.

In prior art, the rigidity of the cage can therefore be increased, and thereby, the precision of the linear guide can be improved.

However, the stiffening structure increases the weight of the cage, which, in turn, can affect the response behavior of the cage.

It is therefore the object of the present invention to provide a linear guide with high precision and a rapid response behavior.

### SUMMARY OF THE INVENTION

This task is solved by means of a linear guide comprising the features according to the invention.

In accordance with one aspect, a linear guide is provided which includes: a first displacement element; a second displacement element that is linearly moveable along a linear direction relative to the first displacement element; at least a first rolling element set, which is provided between the first and second displacement elements and which comprises at least one rolling element, and over which the first and second displacement elements are relatively moveable; and a cage in which at least one rolling element is arranged in a holding section that overlaps with at least one rolling element in the linear direction.

Differing in particular, from prior art, the present invention is characterized in that the cage comprises at least an uneven stiffening structure, which is arranged at least in sections in the holding section and contains at least one recess.

Accordingly, the cage is not designed as a plate with a uniform thickness but is at least in sections in the holding section deviating from a flat shape. This feature allows the cage in the holding section to be stiffened at least in sections, compared to a flat plate shape; however, the uneven stiffening structure cannot simply be created by continuous material thickening in the holding section. Rather, it comprises a recess. In a rectangular cross-section, it is therefore perpendicular to a plane of relative motion along which the displacement elements move relatively, in particular, not as a full profile. This arrangement means that the weight cannot be increased excessively despite the stiffening which allows for a faster response of the linear guide when an external load induces linear motion.

An uneven stiffening structure is to be understood, in particular, as a shape that deviates from a pure plate shape as a full profile. The stiffening structure can therefore increase the geometrical moment of inertia compared to a plate shape in order to increase the bending stiffness. Also, an uneven stiffening structure can comprise a larger cross-sectional area, particularly in a cross-section perpendicular to the linear direction, than a plate-shaped reference cross-section, which comprises the minimum wall thickness, preferably the maximum wall thickness, of the stiffening structure as a thickness and a width in which the stiffening structure extends parallel to a plane of relative motion. Thus, the tensile and compressive stiffness (axial stiffness) can be increased.

On the other hand, the recess can mean a configuration in which a cross-section, in particular, a cross-section perpendicular to the linear direction, comprises a smaller cross-sectional area than a plate-shaped reference cross-section, which comprises the maximum dimension of the stiffening structure perpendicular to the plane of relative motion as a thickness and comprises the width across which the maximum dimension extends parallel to the plane of relative motion, in particular, a direction perpendicular to the linear direction parallel to the plane of relative motion.

Also, a recess can mean a configuration, wherein a maximum dimension of the stiffening structure perpendicular to the plane of relative motion is greater than a maximum wall thickness of the stiffening structure.

In particular, a recess can be formed by a concave section and/or a recess and/or a hole.

In particular, a recess can be provided in a certain direction, in particular, parallel to the plane of relative motion, again, in particular, in a direction perpendicular to the linear direction and/or perpendicular to the plane of relative motion between material of the stiffening structure.

In particular, a recess in this sense is not a recess that comprises a function for holding an element, such as a recess for holding a rolling element or a forced guide element for example.

In particular, the recess can touch or intersect a plane of relative motion that passes through the center point of the rolling element. In addition, or as an alternative, the recess in one direction perpendicular to said plane of relative motion can be provided between the plane of relative motion and an apex of a convex section and/or projection, which is provided to form the uneven stiffening structure.

The plane of relative motion here means a plane along which the first and second displacement elements are relatively mobile with respect to one another. The plane of relative motion contains the linear direction. The plane of relative motion is perpendicular to a direction of arrangement of the first and second displacement elements in which the displacement elements are facing each other, in particular, to base surfaces of the displacement elements. The plane of relative motion can also be a plane that corresponds to the extension plane of the plurality of rolling elements. In other words, the plane of relative motion of an extension plane can correspond to the plurality of receiving holes for receiving at least one of the rolling elements, i.e., a plane that is perpendicular to one direction of penetration of at least one receiving hole (for receiving at least one of the rolling elements). The plane of relative motion can pass through the center point of at least one rolling element and/or receiving hole.

Preferably, the stiffening structure comprises an essentially uniform wall thickness.

Thus, the stiffening structure can be easily formed. It is therefore not necessary to thicken any material of the cage.

In accordance with another aspect, the stiffening structure can comprise at least a concave section and/or at least a recess at least in sections.

Thus, the recess from a surface of the cage can be provided. This feature can simplify production.

Preferably, at least one concave section and/or at least one recess is provided on one side of the cage facing the first displacement element and one side of the cage facing the second displacement element, preferably on both sides of said plane of relative motion.

This arrangement allows the weight of the cage to be reliably reduced. Simultaneously, a certain symmetry, particularly point symmetry, can be created.

Also, the stiffening structure can comprise a convex section and/or at least a projection at least in sections.

Thus, the geometrical moment of inertia can be reliably increased. This embodiment can also make production easier.

Preferably, at least one convex section and/or at least one projection is provided on one side of the cage facing the first displacement element and on one side of the cage facing the second displacement element, preferably on both sides of said plane of relative motion.

Thus, the geometrical moment of inertia can be increased on both sides, and a certain symmetry, particularly point symmetry, can be created.

Furthermore, at least one concave section and/or at least one recess on one side of the cage facing the first displacement element and at least one convex section and/or at least one projection on one side of the cage facing the second displacement element can be provided.

This feature allows the concave section and/or recess as well as the convex section and/or projection to be provided on different sides of the cage, making it easier to manufacture. In particular, production can be carried out via forming. In particular, the provision on different sides can be in such a way that the stiffening structure comprises an essentially uniform wall thickness.

A plurality of convex sections/projections and/or a plurality of concave sections/recesses can be spaced apart from each other in a particular direction, preferably in a regular manner. The specific direction can be a direction parallel to the plane of relative motion, particularly perpendicular to the linear direction. This arrangement can be done on one side of the cage in particular. Again, due to the definition of the plane of relative motion, the direction parallel to the plane of relative motion can be the width direction of the cage, which is perpendicular to the direction of arrangement/direction of penetration and the linear direction.

Preferably, the convex section/projection can be formed in one direction perpendicular to the linear direction, preferably perpendicular to the plane of relative motion, at least partially, preferably completely, overlapping with the concave section/recess.

Thus, the stiffening structure can be produced particularly efficiently by forming convex and concave sections or projections and recesses simultaneously. In other words, the cage can be designed in such a way that the convex section/projection is also formed by forming the concave section/recess. In particular, the convex section/projection can be provided on one side facing the first displacement element and the concave section/recess on a side facing the second displacement element. Here, the cage can also comprise an essentially uniform wall thickness. The direction perpendicular to the plane of relative motion can be the direction of arrangement/direction of penetration.

In other words, in the direction parallel to the plane of relative motion (the width direction of the cage), a concave section/recess on one side and a convex section/projection on the other side can be provided in the same position.

In particular, the apex of the convex section and/or the projection on one side of the cage can be formed in one direction perpendicular to the plane of relative motion, overlapping with the apex of the concave section and/or the recess on the other side.

In accordance with another aspect, the stiffening structure can comprise a profile extruded along a main extension direction.

Thus, the stiffening structure can comprise a preferred direction. In other words, the stiffening structure can be anisotropic.

Preferably, the main extension direction runs parallel to the linear direction.

In particular, the rolling elements can be used to introduce loads parallel to the plane of relative motion, wherein a stiffening structure extruded in the linear direction can increase the axial stiffness of the cage. The bending stiffness can also be increased.

In accordance with another aspect, the stiffening structure can be wave-shaped at least in sections.

Thus, the at least one convex and concave section can be continuously formed. This continuous formation can make production easier. A plurality of wave crests and/or wave troughs can be spaced apart, preferably in a regular manner. In particular, the wave shape can be round on at least one side, preferably on both sides of the cage, i.e., it must not comprise any sharp edges. This feature can reduce stress peaks.

The wave shape can also facilitate the flow of lubricants for the rolling elements.

In addition, or as an alternative, the stiffening structure can be zig-zag-shaped at least in sections.

This arrangement can also provide jagged mountains and valleys that can increase stiffness. Such a shape can be easily established. At least on one side of the cage, the zig-zag shape can comprise a sharp edge. Additionally, the zig-zag shape can make it easier for lubricant to flow.

In accordance with yet another aspect, the linear guide can comprise a second rolling element set parallel to the first rolling element set along the linear direction, the first rolling element set and the second rolling element set can be arranged in the cage, in particular, the cage can be substantially U-shaped as viewed along the linear direction.

Thereby, a common, integral cage can be provided for the two rolling element sets. With such a structure, the cage can be relatively large. Therefore, an increase in stiffness at low weight is particularly favorable. Furthermore, high precision can be achieved for both rolling element sets.

The rolling element sets can be located on opposite sides of the first displacement element, in particular, overlapping in one direction perpendicular to the plane of relative motion.

Preferably, the stiffening structure is located at least between the first rolling element set and the second rolling element set, in particular, in at least one of two limbs of the U-shape.

As a result, not only the holding section can be stiffened but also the area between the rolling element sets. This feature can further increase precision. In particular, a high degree of shape fidelity of the U-shape can be achieved.

In accordance with yet another aspect, the stiffening structure can be formed at least in sections, by forming, in particular, bending and/or deep drawing.

This feature allows the stiffening structure to be achieved by forming. It is therefore possible to produce the stiffening structure cost-effectively.

In accordance with yet another aspect, the cage can include metal, particularly steel, preferably formed from it.

This feature enables high material stiffness in addition to the geometric stiffening. Furthermore, the stiffening structure can be designed in a cost-effective manner. The steel can be stainless steel; however, other types of steel are also conceivable.

In accordance with another aspect, the stiffening structure can be monolithic.

This monolithic stiffening structure can reduce the number of parts. In particular, the stiffening structure can be monolithic with the whole cage.

In accordance with yet another aspect, the first displacement element and/or the second displacement element can comprise a groove in which at least the first rolling element set is provided.

This feature enables precise guidance of the rolling elements. Furthermore, the cage can be brought relatively close to the displacement elements, which requires high precision.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

### In the Drawings,

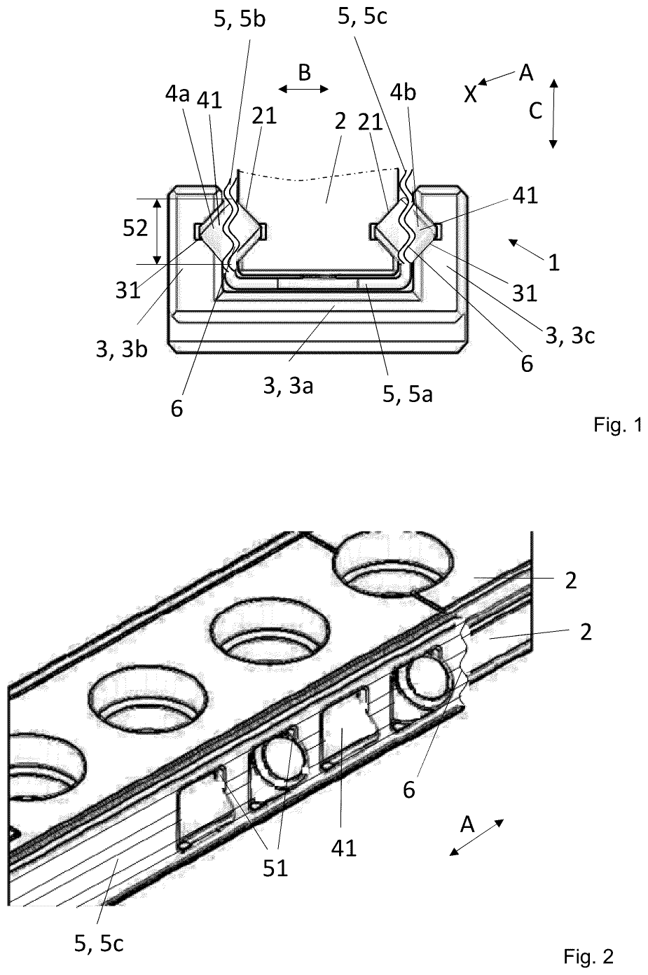

FIG. 1 shows a cross-section through a linear guide;

FIG. 2 shows a perspective side view of the linear guide, wherein a displacement element for better illustration is dispensed with;

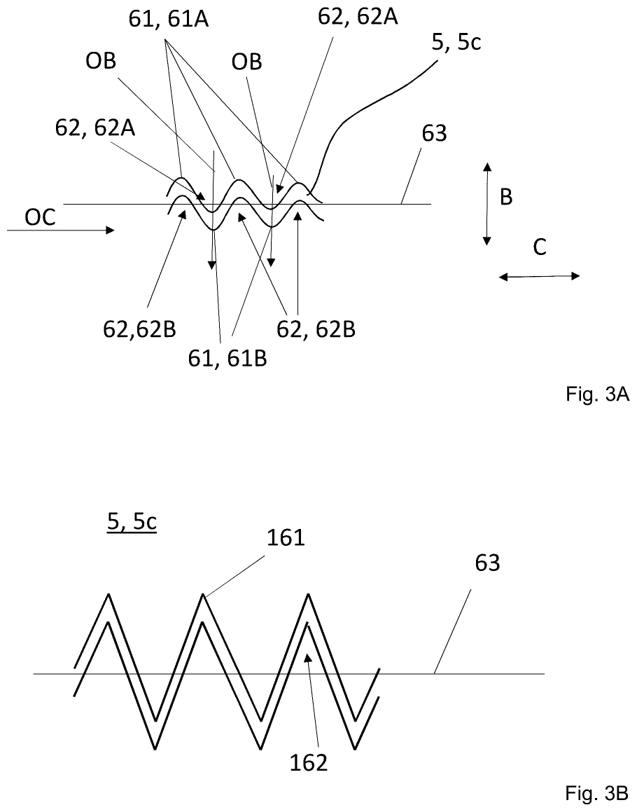

FIG. 3a shows a cage profile in cross-section;

FIG. 3B shows an alternative cage profile in cross-section; and

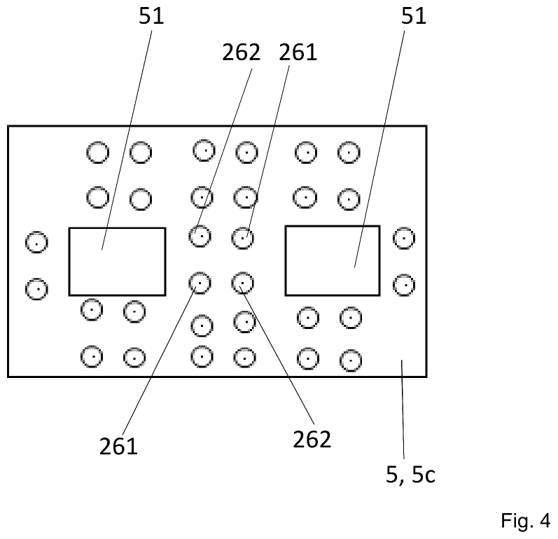

FIG. 4 shows a side view of a cage section in accordance with a further modification.

### DETAILED DESCRIPTION OF PREFERRED EMBODIMENTS

A linear guide 1 is shown in FIG. 1 in cross-section perpendicular to a linear direction A. The linear guide 1 comprises a first displacement element 2 and a second displacement element 3, which are moveable along the linear direction A relative to each other.

The first displacement element 2 can, as is the case here, comprise an essentially rectangular shape with an essentially rectangular cross-section. Said rectangular cross-section extends along the linear direction A.

The second displacement element 3, as shown in FIG. 1, can comprise an essentially U-shaped cross-section, which also extends in linear direction A. The second displacement element 3 can therefore encompass the first displacement element 2. The second displacement element 3 has a floor section 3a, and two limbs 3b and 3c, which extend at both lateral ends of floor section 3a at an essentially right angle to it.

In the first displacement element 2, V-shaped grooves 21 are formed on opposite sides, i.e., on sides facing limbs 3b and 3c, which extend along the linear direction A. The grooves 21 are recessed starting from flat base surfaces. The limbs 3b and 3c of the second displacement element 3 are facing the first displacement element 2 in a width direction B. The width direction B is a direction that runs perpendicular to a plane of relative motion, parallel to which the first and second displacement elements are moveable relative to each other. In other words, the width direction B is the direction along which the displacement elements 2 and 3 are facing each other and overlap with the rolling elements described later. A height direction C is perpendicular to the linear direction A and the width direction B.

The second displacement element 3 comprises corresponding V-shaped grooves 31, wherein a groove 31 is provided on each side of the limbs 3b and 3c facing the first displacement element 2, in particular, in such a way that it is intended to be mirror-symmetrical to the groove 21. The grooves 31 are each recessed starting from a flat base surface.

The grooves 21 and 31 are each provided at the same height in the height direction C and overlap each other in the width direction B.

Between the first displacement element 2 and 3, a first rolling element set 4a and a second rolling element set 4b are provided in the width direction B.

The first rolling element set 4a is arranged in groove 21, which faces the limb 3b, and the corresponding groove 31. The second rolling element set 4b is provided in groove 21, which is facing the limb 3c, and the corresponding groove 31. Each rolling element set 4a and 4b comprises a plurality, in particular, the same number, of rolling elements 41 spaced from each other, preferably in a regular manner, along the linear direction A, as shown in FIG. 2. The rolling elements 41 are arranged along an arrangement direction (width direction B) in which the displacement elements 2 and 3 are facing each other, between the displacement elements 2 and 3, in particular, their base surfaces.

The rolling elements 41 can be designed as cylindrical rollers as is the case here. In the present example, see FIG. 2, the axes of the cylindrical rollers are rotated alternately by 90°. The axes are each inclined by 45°in different directions with respect to the plane of relative motion.

### The first and second rolling element sets 4a and 4b are arranged in a common cage 5.

The cage 5 comprises receiving holes 51 corresponding to the rolling elements 41, which are also spaced along the linear direction, preferably in a regular manner, and in each of which a rolling element 41 is arranged. The receiving holes 51 and the rolling elements define an extension plane parallel to the height direction C and the linear direction A. The extension plane forms the plane of relative motion. The receiving holes 51 penetrate the cage in the direction of arrangement. In other words, the direction of arrangement is parallel to a direction of penetration and perpendicular to the plane of relative motion.

The cage 5 comprises an essentially U-shaped shape in cross-section (FIG. 1). The cage 5 comprises a floor section 5a and two limbs 5b and 5c, which extend at both lateral ends of floor section 5a at an essentially right angle, wherein the transition can be rounded on both sides.

Floor section 5a is essentially provided parallel to floor section 3a of the second displacement element 3. It is arranged in height direction C between floor section 3a of the second displacement element 3 and an underside of the first displacement element 2.

The limbs 5b and 5c are each arranged in the width direction B between the respective limbs 3b and 3c of the second displacement element 3 and the side of the first displacement element 2 correspondingly facing it. In other words, the cage 5 can be located in an intermediate space between the first and second displacement elements. The cage 5 is located outside grooves 21 and 31.

The cage 5 comprises a holding section 52 in each limb 5b and 5c. The holding section 52 is an area that overlaps with rolling elements 41 along linear direction 5.

The cage 5 can be symmetrical with respect to a plane that runs through the middle of the floor section 5a and extends parallel to a plane of relative motion.

Furthermore, the cage 5 comprises an uneven stiffening structure 6, which is located within the holding section 52 at least in sections. The uneven stiffening structure 6 is here wave-shaped, as can be seen in particular, in FIG. 3A.

The uneven stiffening structure 6 is formed at least in the holding section 52, forming this section in particular; however, as is the case here, the uneven stiffening structure 6 can also extend across the entire limb 5b and 5c of the cage 5. Even if not shown, the stiffening structure 6 can extend across the entire cage 5, i.e., also across the floor section 5a. The stiffening structure 6 can therefore also be provided between the rolling element sets 4a and 4b.

The uneven stiffening structure 6 can be formed as a profile as here, which extends along a main extension direction, in this case, the linear direction A. It preferably extends across the entire extension of the cage 5 in the linear direction, or at least across half of it, preferably 80% of it.

In cross-section, the profile can be formed as shown in FIG. 3A. In particular, the stiffening structure 6 can comprise at least one convex section 61, preferably a plurality of them. The at least one convex section 61 can be located in holding section 52. The at least one convex section 61 can be formed as a wave crest, as here.

Furthermore, the uneven stiffening structure 6 comprises at least one recess, preferably a plurality of them. The at least one recess can be formed by a concave section 62, particularly wave trough, as is the case here. There is also a recess between adjacent wave crests on the same side (for example, on the side facing the first displacement element) along the height direction C.

If the convex sections are not distinguished in this description, they are generally indicated as 61. If the concave sections are not distinguished in this description, they are generally indicated as 62.

At least one recess and at least one convex section 61, preferably a plurality respectively, for example, two or three of them, can be provided for as here in holding section 52; however, the uneven stiffening structure 6, i.e., convex and concave sections, can connect, particularly continuously, to the uneven stiffening structure 6 in the holding section 52.

In the wave-shaped profile, convex and concave sections merge continuously, as shown in FIG. 3A. The change takes place at the plane of relative motion 63. The recess therefore touches the plane of relative motion. The recess (concave section 62) is provided between the plane of relative motion 63 and the apex of the convex section 61 in the width direction B. The plane of relative motion 63 is defined in accordance with the above embodiments and can pass, for example, through the center point of the rolling elements 41 and/or the receiving holes 51.

It should be noted that the profiles in FIGS. 3A and 3B are rotated by 90°compared to FIG. 1.

On both sides of the cage 5, i.e., on the side facing the first displacement element 2 and the side facing the second displacement element 3, the convex sections 61 and concave sections 62 are provided alternately along the height direction C (width direction of the cage 5) on one side respectively (the side facing the first displacement element and the side facing the second displacement element). The convex sections 61 and concave sections 62 overlap each other in the height direction C.

To distinguish the two sides of the cage, the sections on one side are designated by the index “A” in FIG. 3A, while the sections on the other side are designated by the index “B”.

In width direction B (thickness direction of the cage 5), a convex section 61A and a concave section 62B overlap each other, as indicated by the arrow OB. In particular, the overlap is so complete that an essentially uniform wall thickness results. In particular, the respective apexes overlap. Convex sections 61A and 61B are spaced or staggered from each other in the height direction C (do not overlap in the width direction B). The concave sections 62A and 62B are spaced or offset from each other in the height direction C (do not overlap in the width direction B). With reference to FIG. 3A, it should be explained again that a convex section 61A on one side and a concave section 62B on the other side are arranged in the cross-section in the direction parallel to the plane of relative motion (height direction C, direction perpendicular to the direction of arrangement) at essentially the same position. Likewise, a convex section 61B on the other side and a concave section 62A on one side are arranged in the direction parallel to the plane of relative motion (height direction C) in essentially the same position.

As mentioned above, a convex section 61A on one side and a concave section 62B on the other side overlap in the height direction C (width direction of the cage), as indicated by the arrow OC. In other words, a convex section 61A on one side encloses the concave section 62B on the other side, as viewed in the height direction C.

Furthermore, the plurality of convex sections 61A/61B, each provided on one side, overlap along the height direction. In particular, the apices are congruent when projected along the height direction C. Furthermore, the plurality of concave sections 62A/62B, which are provided on one side, overlap along height direction C. In particular, the apices are congruent when projected along the height direction C.

The convex sections 61A on one side and the concave sections 62B on the other side, as well as the convex sections 61B and the concave sections 62A can be produced by forming, for example by bending or deep drawing. This feature also applies to projections and recesses.

A plane of relative motion passing through the center points of the rolling elements 41 is indicated as 63. The convex sections 61 and concave sections 62 are formed on both sides of the plane of relative motion 63. In particular, the convex sections 61A are provided on one side of the plane of relative motion 63, and the convex sections 61B on the other. The concave sections 62A are provided on the other side of the plane of relative motion 63, while the concave sections 62B are provided on one side.

In other words, on one side of the cage 5, the convex section 61A merges into the concave section 62A at the plane of relative motion 63 and vice versa (inflection point). This feature can also apply to a projection and a recess.

The apices of convex sections 61 and concave sections 62 can be evenly spaced along height direction C (width direction of the cage 5), as is the case here. Also, the apices can each have the same distance from the plane of relative motion 63.

The apices of the convex sections 61 are preferably spaced from the plane of relative motion 63 by at least half of the maximum width (in the width direction of the cage) of the convex section 61. Preferably, the convex section 61 has at least the height (distance of the apex) that corresponds to the maximum width. The height can also correspond to at least a quarter, preferably at least half, of the width of the holding section 52 (in the width direction of the cage 5).

The concave section 62 (apex of it) can comprise a distance from the plane of relative motion reduced by one wall thickness of the stiffening structure compared to the distance of the convex section 61. The apices of the concave sections 62 are preferably spaced from the plane of relative motion 63 by at least half of the maximum width (in the width direction of the cage) of the concave section 62. The concave section 62 can be spaced from the plane of relative motion by at least half the distance of the convex section, preferably by at least 80%.

At least one convex section 61 can be provided on both sides of the plane of relative motion 63, as is the case here, in particular, in the holding section 52. The same applies to the concave section 62, which can also be provided on both sides of the plane of relative motion.

The uneven stiffening structure 6 can comprise an essentially uniform wall thickness, as is the case here. By providing a convex section 61A on one side of the cage and the concave section 62B on the other side, uniform wall thickness can be ensured.

The uneven stiffening structure 6 is provided between at least two, preferably all, of the receiving holes 51. It can extend in linear direction A to the edge of the receiving holes 51 (i.e., the edge in a transverse direction to linear direction A) or end at a small distance from it, for example one third, preferably a quarter of the dimension of a receiving hole 51 in the linear direction. It can also extend across at least half, preferably 75%, of the length of an intermediate space in linear direction A between adjacent receiving holes 51.

The uneven stiffening structure can form the entire edge of the receiving holes 51. Thereby, the edge running in linear direction A can also be formed by the uneven stiffening structure 6.

Functions and effects of the invention are now described.

The first displacement element 2 and the second displacement element can be displaced axially, i.e., along the linear direction A, when an external load is applied. The rolling elements 41 can carry out a rolling movement in the grooves 21 and 31. The cage 5 can support rolling elements 41.

The convex sections 61 of the uneven stiffening structure 6 result in a stiffening of the cage 5. This stiffening prevents excessive deformation of the cage 5 which ensures a high precision of the linear guide.

The stiffening can be based, in particular, on the increase in the geometrical moment of inertia and/or the cross-sectional area compared to a rectangular reference cross-section. As is the case here, the cross-sectional area in the entire holding section 52 can be increased compared to a rectangular reference cross-section, wherein the comparative cross-section across the holding section 52 (in the width direction of the cage, in this case in the height direction C) is formed with the same wall thickness (thickness, here in the width direction B) as that of the uneven stiffening structure 6.

However, that the stiffening structure comprises a recess 62 can prevent excessive weight gain. As is the case here, the recess can cause the cross-sectional area in the holding section 52 to be smaller than a rectangular reference cross-section as a full section, which comprises the width of the holding section 52 (or a width between two adjacent apices on either side of the cage 5) in the width direction of the cage 5 (height direction C), and which comprises the maximum dimension of the uneven stiffening structure 6 perpendicular to the plane of relative motion 63 as thickness (width direction B). The maximum dimension perpendicular to the plane of relative motion is defined by the distance of the respective apices on either side of the cage 5/plane of relative motion 63.

The uneven stiffening structure 6 is formed in such a way that a convex section 61 overlaps with a concave section 62 in one direction perpendicular to the plane of relative motion 63, i.e., in the direction of arrangement. Thus, the convex section 61 can be formed particularly easily by forming the concave section 62 simultaneously. Simultaneously, a uniform wall thickness can be provided.

The wave shape can comprise a sinusoidal shape. This sinusoidal shape can make production easier.

The flanks of the convex 61 and/or concave sections 62 can form an angle of at least 60°, preferably 80°, even more preferably of 90°, with the plane of relative motion (at the intersection with the plane of relative motion). This feature makes it particularly easy to increase the geometrical moment of inertia. A large area can also be provided for connecting the rolling elements 41.

The uneven stiffening structure 6 can be symmetrical with respect to a central plane of the holding section 52 that runs perpendicular to the plane of relative motion 63 through a center point of the rolling elements 41 and/or receiving holes 51. For example, the median plane can divide a convex section or concave section in the center. Thus, uniform deformation can be achieved.

It is favorable if the uneven stiffening structure 6 is made by bending. This feature simplifies production.

The stiffening structure 6, preferably the entire cage 5, can be monolithic as is the case here. This feature means that production can be further simplified.

The stiffening structure 6, preferably the whole cage 5, can be made of stainless steel.

The stiffening structure 6, preferably the entire cage, can be designed as a sheet metal part. The wall thickness of this can be a maximum of 1 mm, preferably 0.5 mm, again preferably, 0.1 mm.

Variations are now described.

In FIG. 3B, instead of a wave-shaped profile, a profile with a zigzag shape is shown. Where the convex sections 61 and concave sections 62 in FIG. 3A are round, the convex sections 161 and concave sections 162 can be formed with an edge. The other embodiments correspond to those of FIG. 3A. The plane of relative motion 63 is also shown.

Furthermore, the recess does not have to be formed by a concave section. For example, as shown in FIG. 4, at least in the holding section along the width direction of the cage 5 (height direction C in FIG. 1), a plurality of projections 261 and recesses 262 can be provided in a flat plate of the limb 5c, in which the receiving holes 51 are provided. The recesses 262 can overlap with the projections 261 in the thickness direction (perpendicular to the drawing plane), i.e., the direction of arrangement/penetration. A part of the projections 261 is formed on one side of the cage 5, for example the side facing the first displacement element; another part of the projections 261 is formed on the other side.

Here, the formation of projections on one side and recesses on the other side also provides for an essentially uniform wall thickness. This arrangement can be done by forming, wherein the projection is simultaneously formed by forming the recess.

Instead of an integral cage, which is formed by connecting the two limbs 5b and 5c through the floor section 5a, as is the case here, two separate cages can be provided. These cages can then be provided between the limbs 3b and 3c of the second displacement element and the first displacement element 2. The cages can then each comprise the aforementioned uneven stiffening structure.

Furthermore, the above embodiment is not limited to a U-shape of the cage 5 and/or the second displacement element 3. For example, a cage can be provided that extends in its entirety essentially parallel to a plane of relative motion.

The rolling element sets can also be provided essentially on one plane.

Only one rolling element set can also be provided.

At the top, the stiffening structure 6 comprises a main extension direction (linear direction) along which the profile is extruded; however, the uneven stiffening structure 6 can also be provided two-dimensionally along the plane of relative motion, as is the case in FIG. 4. A plurality of projections and recesses, i.e., convex and concave sections, can be isotropic with respect to the plane of relative motion.

The cage can be forcibly guided. For this purpose, a forced guide element, such as a gear, can be coupled to the cage.

Instead of cylindrical rollers, for example, balls can be used as rolling elements whose axes are aligned parallel to the plane of relative motion.

Although only a few embodiments of the present invention have been shown and described, it is to be understood that many changes and modifications may be made thereunto without departing from the spirit and scope of the invention.

What is claimed is:

1. A linear guide (1), comprising:
a first displacement element (2);
a second displacement element (3) which is linearly moveable along a linear direction (A) relative to the first displacement element (2);
at least one first rolling element set (4a) which is provided between the first (2) and second displacement elements (3) and which comprises at least one rolling element (41) and over which the first (2) and second displacement elements (3) are relatively moveable; and
a cage (5) in which at least one rolling element (41) is arranged in a holding section (52) which overlaps in the linear direction (A) with that of at least one rolling element (41), wherein
the cage (5) comprises at least one uneven stiffening structure (6), which is arranged at least in sections in the holding section (52) and contains at least one recess (62).

2. The linear guide (1) according to claim 1, wherein the stiffening structure (6) comprises an essentially uniform wall thickness.

3. The linear guide (1) according to claim 1, wherein the stiffening structure (6) comprises at least in sections at least one concave section (62, 162) and/or at least a recess, preferably at least one concave section (62, 162) and/or a recess on one side of the cage (5) facing the first displacement element (2) and on one side of the cage (5) facing the second displacement element (3).

4. The linear guide (1) according to claim 1, wherein the stiffening structure (6) comprises at least one convex section (61, 161) and/or a projection at least in sections, preferably at least one convex section (61, 161) and/or a projection on one side of the cage (5) facing the first displacement element (2) and on one side of the cage (5) facing the second displacement element (3).

5. The linear guide (1) according to claim 3,
wherein the stiffening structure (6) comprises at least one convex section (61, 161) and/or a projection at least in sections, preferably at least one convex section (61, 161) and/or a projection on one side of the cage (5) facing the first displacement element (2) and on one side of the cage (5) facing the second displacement element (3), and
wherein at least one concave section (62) and/or at least one recess on one side of the cage (5) facing the first displacement element (2) and at least one convex section (61) and/or at least one projection on one side of the cage (5) facing the second displacement element (3) is provided so that the stiffening structure comprises an essentially uniform wall thickness.

6. The linear guide (1) according to claim 3, wherein
the stiffening structure (6) comprises at least one convex section (61, 161) and/or a projection at least in sections, preferably at least one convex section (61, 161) and/or a projection on one side of the cage (5) facing the first displacement element (2) and on one side of the cage (5) facing the second displacement element (3), and
wherein the convex section (61, 161) and/or the projection is formed in one direction perpendicular to the linear direction (A), preferably perpendicular to a plane of relative motion (63) at least in sections, in particular, completely, overlapping with the concave section (62, 162) and/or the recess, in particular, the apex of the convex section (61, 161) and/or the projection on one side of the cage (5) is formed in one direction perpendicular to the plane of relative motion (63) overlapping with the apex of the concave section (62, 162) and/or the recess on the other side of the cage (5).

7. The linear guide (1) according to claim 1, wherein the stiffening structure (6) comprises a profile extruded along a main extension direction (A), wherein the main extension direction runs parallel to the linear direction (A).

8. The linear guide (1) according to claim 1, wherein the stiffening structure (6) is wave-shaped at least in sections.

9. The linear guide (1) according to claim 1, wherein the stiffening structure (6) is zig-zag-shaped.

10. The linear guide (1) according to claim 1, wherein
the linear guide (1) comprises a second rolling element set (4b) parallel to the first rolling element set (4a) along the linear direction (A), and
the first rolling element set (4a) and the second rolling element set (4b) are arranged in the cage (5), in particular, the cage (5) is essentially U-shaped as viewed along the linear direction (A).

11. The linear guide (1) according to claim 10, wherein the stiffening structure (6) is arranged at least between the first rolling element set (4a) and the second rolling element set (4b), in particular, in at least one of two legs (5b, 5c) of the U-shape.

12. The linear guide (1) according to claim 1, wherein the stiffening structure (6) is formed at least in sections by forming, in particular, bending and/or deep drawing.

13. The linear guide (1) according to claim 1, wherein the cage (5) comprises metal, particularly steel, preferably formed from metal.

14. The linear guide (1) according to claim 1, wherein the stiffening structure (6) is monolithic.

15. The linear guide (1) according to claim 1, wherein the first displacement element (2) and/or the second displacement element (3) comprises a groove (21, 31) in which at least the first rolling element set (4a) is provided.
